(19) United States
(12) Patent Application Publication
(10) Pub. No.: US 2008/0061543 A1
(43) Pub. Date: Mar. 13, 2008

(54) Undercarriage storage slide-out

(76) Inventor: Stewart E. Gardner, Bristol, IN (US)

Correspondence Address: R. TRACY CRUMP, P.O. BOX 604, 32790 DUNN ROAD, NEW CARLISLE, IN, 46552, US

(21) Appl. No.: 11/893,099

(22) Filed: Aug. 14, 2007

Related U.S. Application Data
(60) Provisional application No. 60/837,526, filed on Aug. 14, 2006.

(51) Int. Cl. B60R 11/02; B60R 9/00

(52) U.S. Cl. 280/769

(57) ABSTRACT

The slide-out undercarriage storage apparatus includes a storage bin or tray and a slide-out mechanism, which allows the bin or tray to be manually pulled between a retracted storage position and an extended open position. The slide-out mechanism includes a pair of fixed frame rails, a pair slide rails and three pairs of track rollers. The slide rails are nested within corresponding frame rails and supported by three track rollers, which allow the slide rails to shift longitudinally about the frame rails. Each of the frame and slide rails have a perpendicular flat flange and a V-shaped flange. One pair of track rollers are mounted to the front end of the frame rails. Two track rollers are rotatably mounted to the slide rails, one located at the back of the slide rail and at an intermediate position along the slide rail. V-shaped flanges of the frame and slide rails have slanted inner faces that provides a race for two of the track rollers. The flat flange of the frame rails provides a race for the other track rollers.

This invention relates to undercarriage storage units in recreational and utility vehicles, and in particular a slide-out mechanism for undercarriage storage units.

### BACKGROUND OF THE INVENTION

Undercarriage storage compartments and bins have been common features in utility vehicles and class A recreational vehicles. Undercarriage compartments and bins are used to store various vehicle items, equipment and luggage. While common features in utility and recreational vehicles, the accessibility to store items limits the usefulness of undercarriage compartments and bins. Often a user is required to crawl into the compartment to retrieve or access items and equipment stored deep within the compartments.

### SUMMARY OF THE INVENTION

Each of the undercarriage storage slide-out units embodying the present invention include a slide-out mechanism, which supports the storage bin or tray beneath the undercarriage and allows the bin or tray to be manually pulled from a storage position and an extended position. The slide-out mechanism includes a pair of fixed frame rails, a pair of slide rails and three pairs of track rollers. The slide rails are nested within corresponding frame rails and supported by three track rollers, which allow the slide rails to shift longitudinally about the frame rails. Each of the frame and slide rails have a perpendicular flat flange and a V-shaped flange. One pair of track rollers is mounted to the front end of the frame rails. Two track rollers are rotatably mounted to the slide rails, one located at the back and one located at an intermediate position along the slide rail. V-shaped flanges of the frame and slide rails have slanted inner faces that provide a race for two of the track rollers. The flat flange of the frame rails provides a race for the other track rollers. The track rollers are rotatably mounted so that they ride in constant contact with the flat flanges and the V-flange of the frame or slide rails.

One embodiment of the present invention uses the slide-out mechanism to shiftably support a storage bin, which can carry luggage and other items. Other embodiments use the slide-out mechanism to shiftably support a flat equipment tray upon which an electrical generator and a cooking grill are mounted. In each embodiment, the slide-out mechanism allows ready access to items stored beneath the undercarriage of vehicles. The storage bins and trays move easily between the retracted and extended positions, regardless of the weight of the items carried by the bins or trays. The use of the V-shaped flanges on the rails and three track rollers prevents binding and ensures that the bins and trays slide easily even under a heavy load.

These and other features of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of an undercarriage storage slide-out unit embodiment of this invention shown in a retracted storage position;

FIG. 2 is a perspective view of the undercarriage storage slide-out unit of FIG. 1 shown in an extended open storage position;

FIG. 3 is a partial front view of the undercarriage storage slide-out unit of FIG. 1;

FIG. 4 is a side view of the undercarriage storage slide-out unit of FIG. 1 shown in the retracted storage position;

FIG. 5 is a side view of the undercarriage storage slide-out unit of FIG. 1 shown in the extended open position;

FIG. 6 is a partial exploded view of the undercarriage storage slide-out unit of FIG. 1;

FIGS. 7-9 are partial sectional views of the undercarriage storage slide-out unit of FIG. 1 taken along lines 7-7, 8-8 and 9-9 respectively;

FIG. 10 is a perspective view of a second undercarriage storage slide-out unit embodiment of this invention shown in a recreational vehicle;

FIG. 11 is a perspective view of the undercarriage storage slide-out unit of FIG. 10;

FIG. 12 is an exploded view of the undercarriage storage slide-out unit of FIG. 10;

FIG. 13 is a side view of the undercarriage storage slide-out unit of FIG. 10 shown in the retracted storage position;

FIG. 14 is a side view of the undercarriage storage slide-out unit of FIG. 10 shown in the extended open position;

FIGS. 16-17 are partial sectional views of the undercarriage storage slide-out unit of FIG. 10 taken along lines 7-7, 8-8 and 9-9 respectively;

FIG. 18 is a perspective view of a third undercarriage storage slide-out unit embodiment of this invention shown in a recreational vehicle;

FIG. 19 is an end view of the undercarriage storage slide-out unit of FIG. 18 shown in the retracted storage position;

FIG. 20 is a partial top view of the undercarriage storage slide-out unit of FIG. 18 shown in the retracted storage position showing the tray turret;

FIG. 21 is a partial top view of the undercarriage storage slide-out unit of FIG. 18 shown in the extended position with a grill mounted to the tray; and

FIGS. 22-24 are partial top views of the undercarriage storage slide-out unit of FIG. 18 shown in the extended position showing the rotation of the grill on the tray turret.

### DESCRIPTION OF THE PREFERRED EMBODIMENT

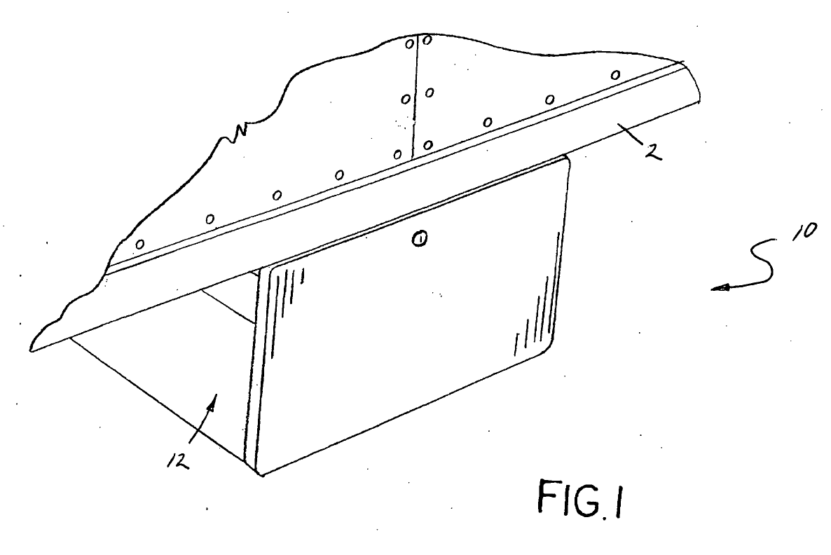

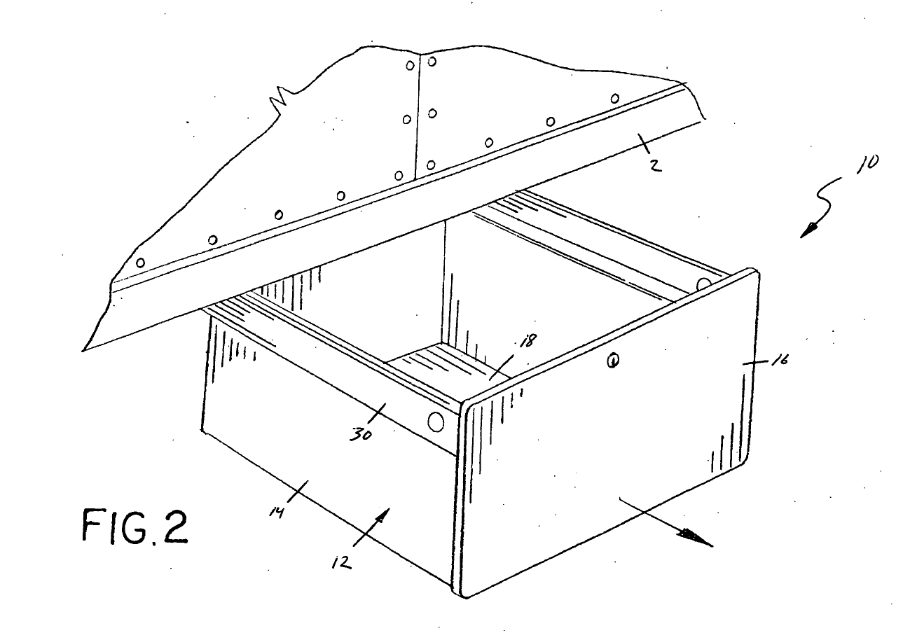

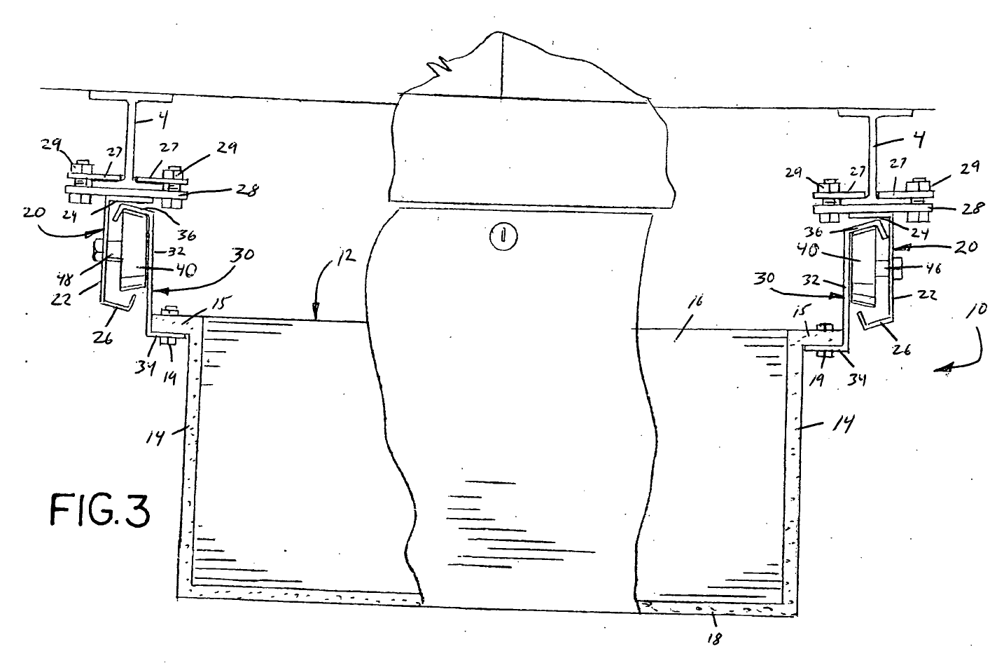

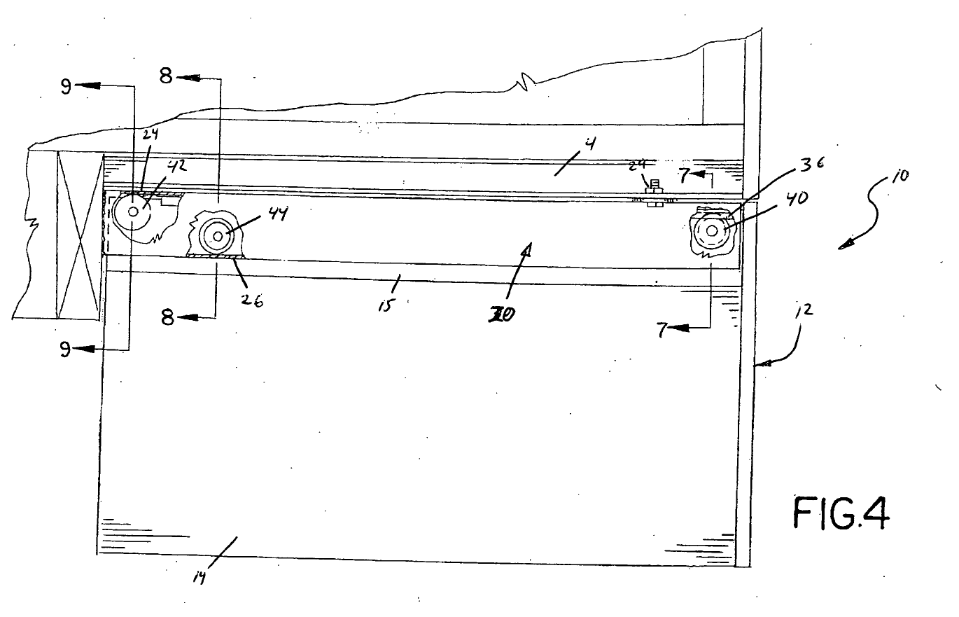

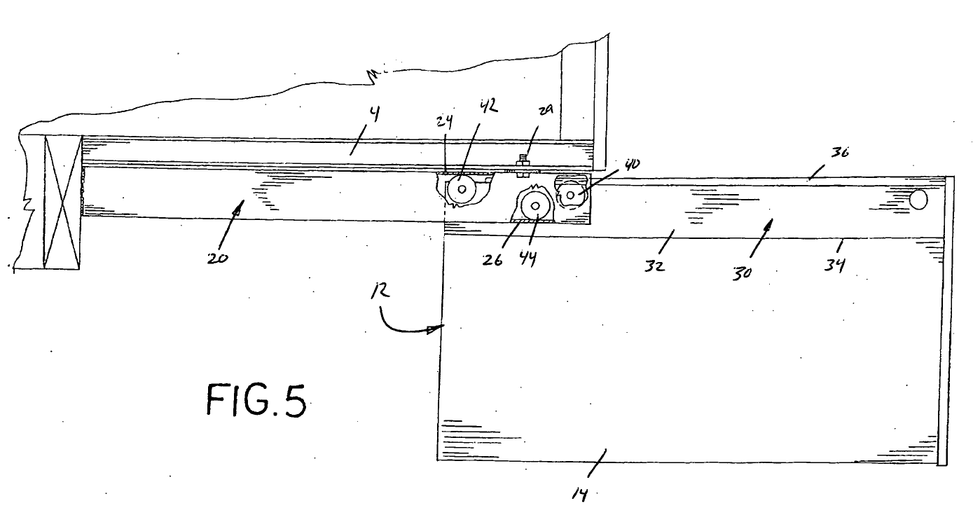

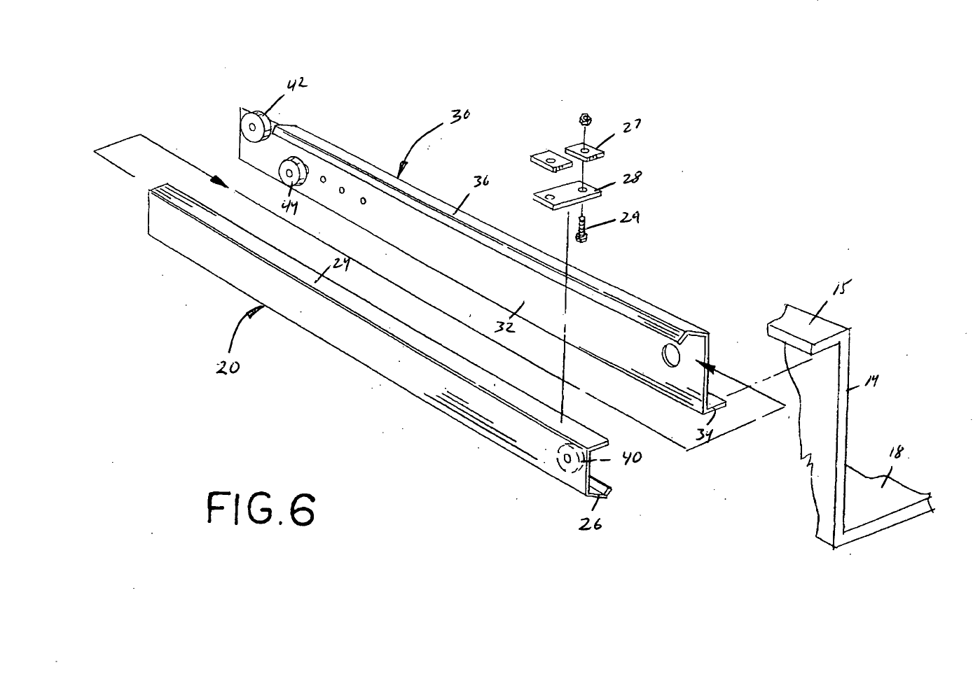

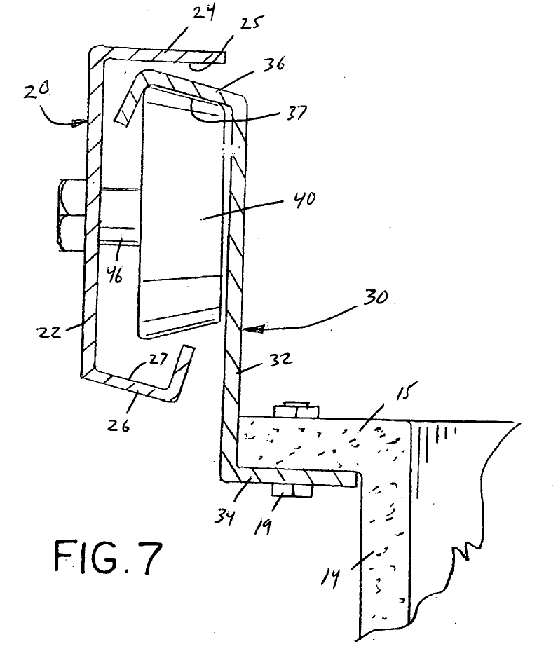

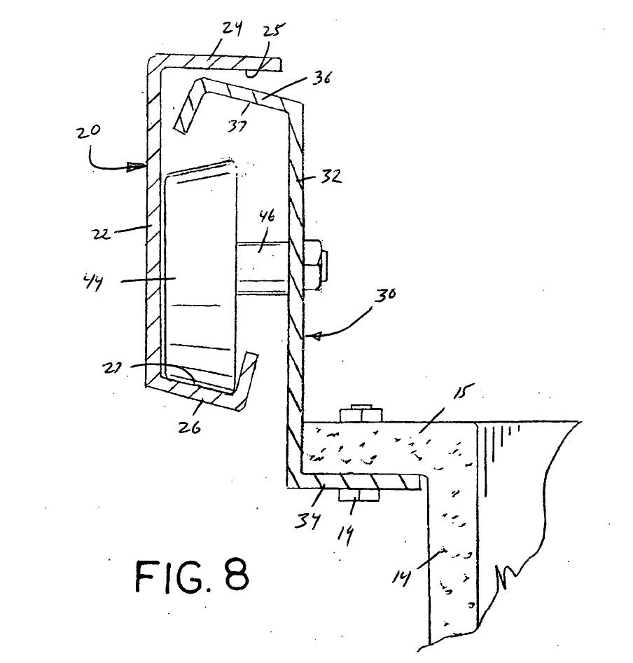

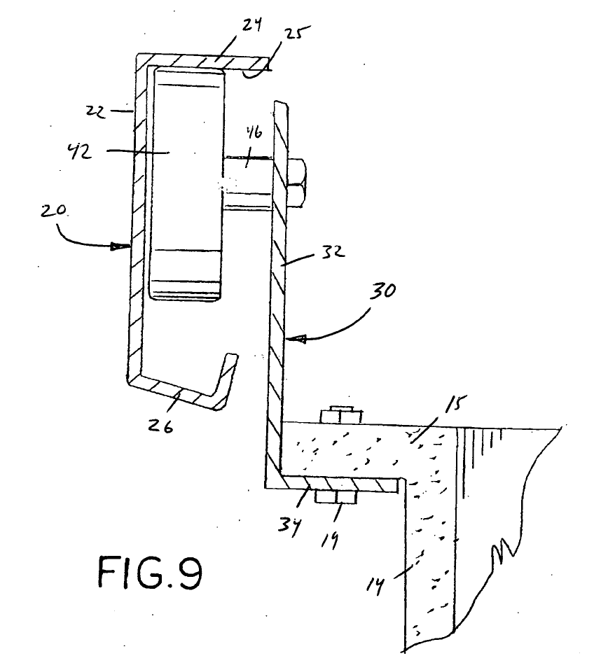

FIGS. 1-9 illustrate an embodiment of the undercarriage storage slide-out unit of this invention, which is generally designated as reference numeral 10. Storage apparatus 10 includes a storage bin 12 mounted beneath the undercarriage 2 of a utility or recreational vehicle by a slide-out mechanism that allows the bin to be manually pulled from a storage position and an extended position.

The slide-out mechanism includes a pair of frame rails 20, a pair slide rails 30 and three pairs of track rollers 40, 42 and 44. Slide rails 30 are nested with corresponding frame rails 20 and supported by track rollers 40, 42 and 44, which are mounted to the frame and slide rails to allow the slide rails to shift longitudinally about the frame rails. Both frame and slide rails 20 and 30 consist of lengths of elongated channel preferably constructed of a sturdy, rigid light-weight material, which is able to withstand repetitive use, such as steel. Both frame and slide rails 20 and 30 have a similar cross section with an integral flat back 22, 32, a perpendicular flat flange 24, 34 and a V-shaped flange (referred to as V-flange) 26, 36, respectively.

As shown, track rollers 40, 42 and 44 are mounted in a substantially vertical position, such that the axis of rotation of track rollers are substantially orthogonal to the longitudinal axis of rails. Each track roller 40, 42 and 44 is rotatably mounted to a frame or slide rail on axle 46 and is free to spin about the axle. Each track roller 40, 42 and 44 is configured and arranged to provide a “floating” wheel assembly. That is, the track rollers are deliberately mounted to allow for some lateral or side-to-side movement with respect to the rail. The amount of lateral play provided the track roller may be varied for each embodiment or application. The use of this “floating” wheel assembly compensates for tolerance inaccuracies between rails, the storage bin and installation.

Track roller 40 is mounted to the front end of frame rail 20. Track rollers 42 are rotatably mounted to the back end of slide rails 30 and track rollers 44 are rotatably mounted at an intermediate position to slide rails 30. V-flanges 26 and 36 of frame and slide rails 20 and 30 have slanted inner faces 27 and 37 that provide a race for rollers 40 and 44. Flat flanges 24 of frame rail 20 have an inner face 25 that provides a race for roller 42. It should be noted that each track roller 40, 42 and 44 is mounted to frame rails 20 and slide rails 30 to be in constant rolling contact with either flat flange 24 or V-flanges 26 and 36 of the other rail.

As shown, storage bin 12 has a rectangular open top configuration defined by side 14, end walls 16 and bottom 18. As shown, storage bin 12 is mounted between slide rails 30 by fasteners 19 that extend through holes in rail flat flange 34 and bin side flanges 15. Frame rails 20 are welded or otherwise secured to a mounting plate 28, which is clamped to undercarriage beams 4 by clamp brackets 27 and fasteners 29. In the storage position, most of the weight of the bin is carried by track rollers 40 and 44. As the storage bin is pulled out and slide rails 30 are extended from frame rails 20 past half their length, the weight of storage bin 12 rides on track rollers 40 and 42, where track rollers 42 ride under flat flanges 24 of frame rails 20.

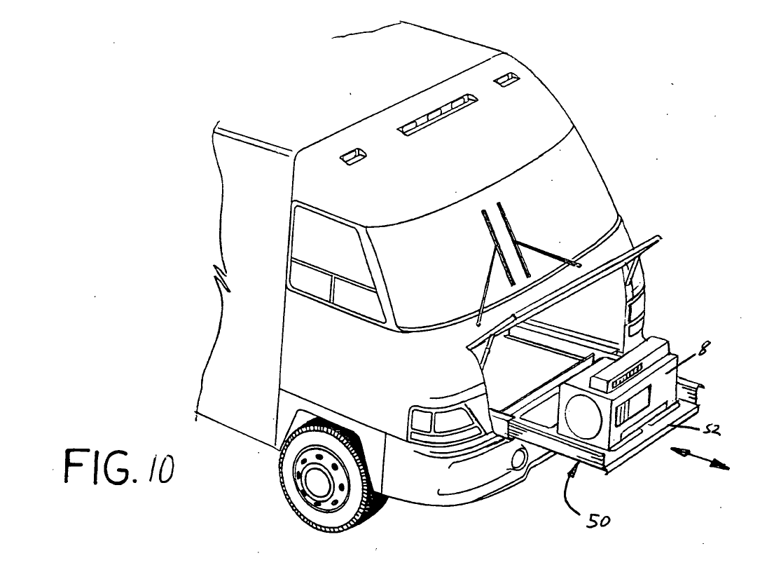

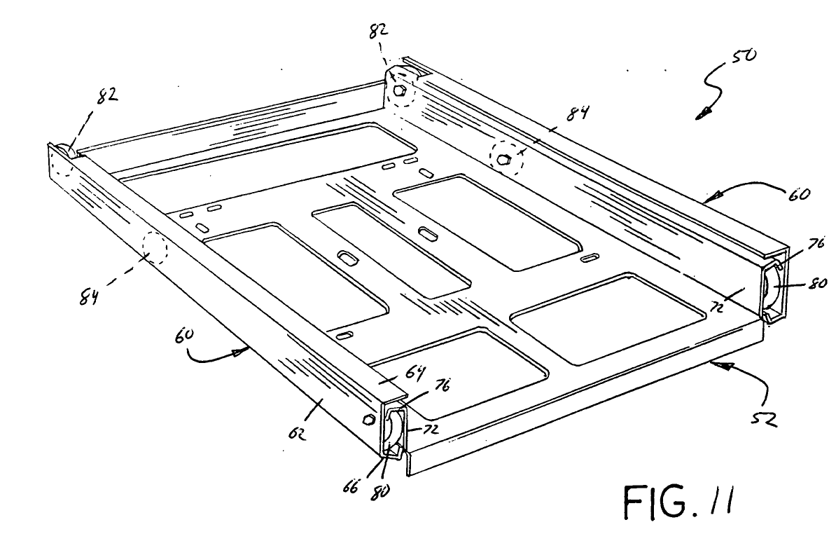

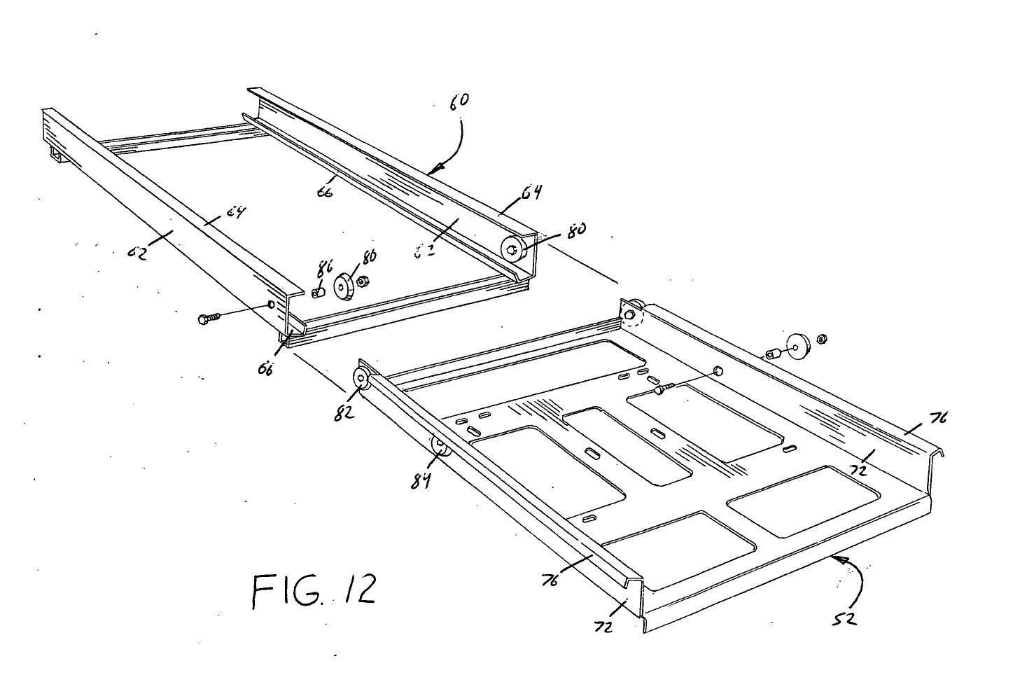

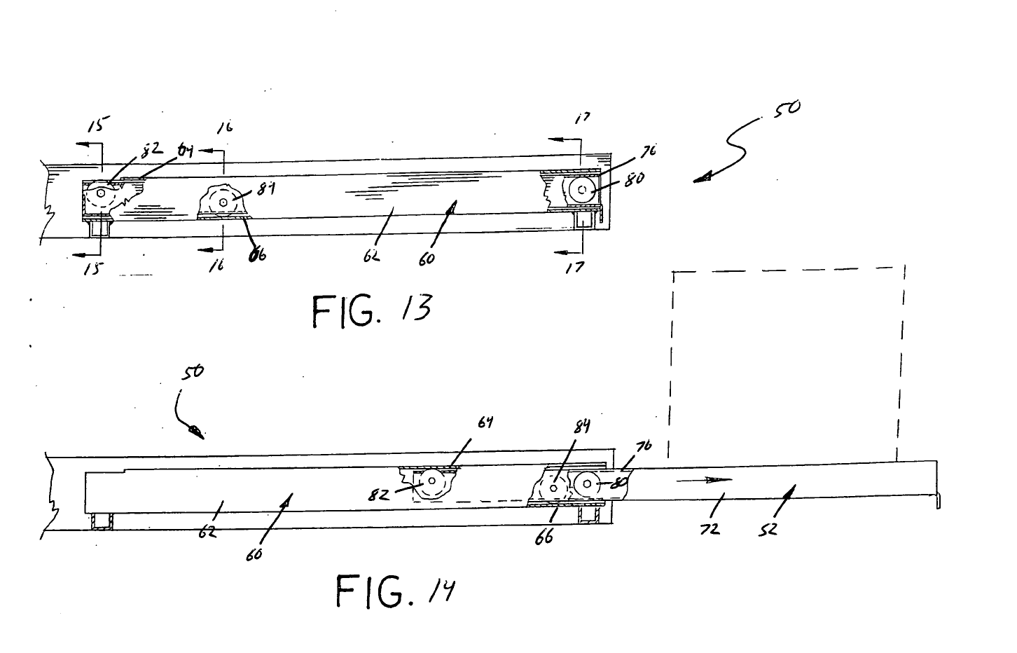

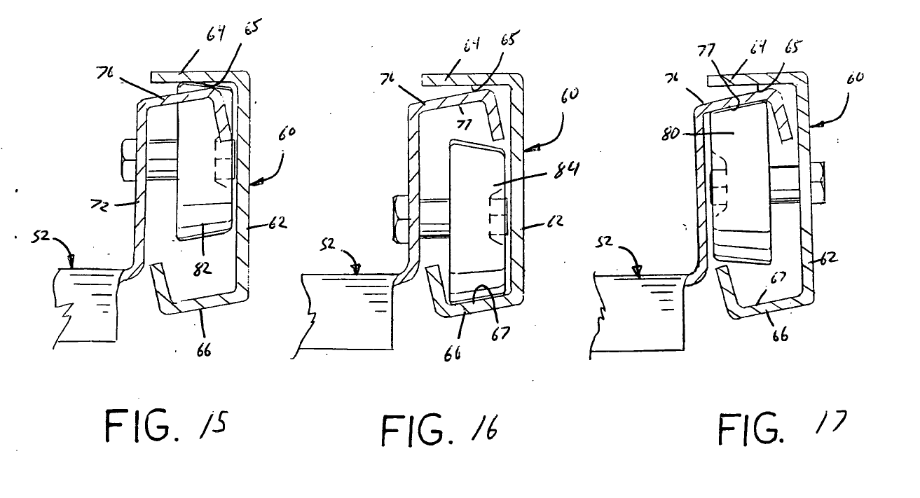

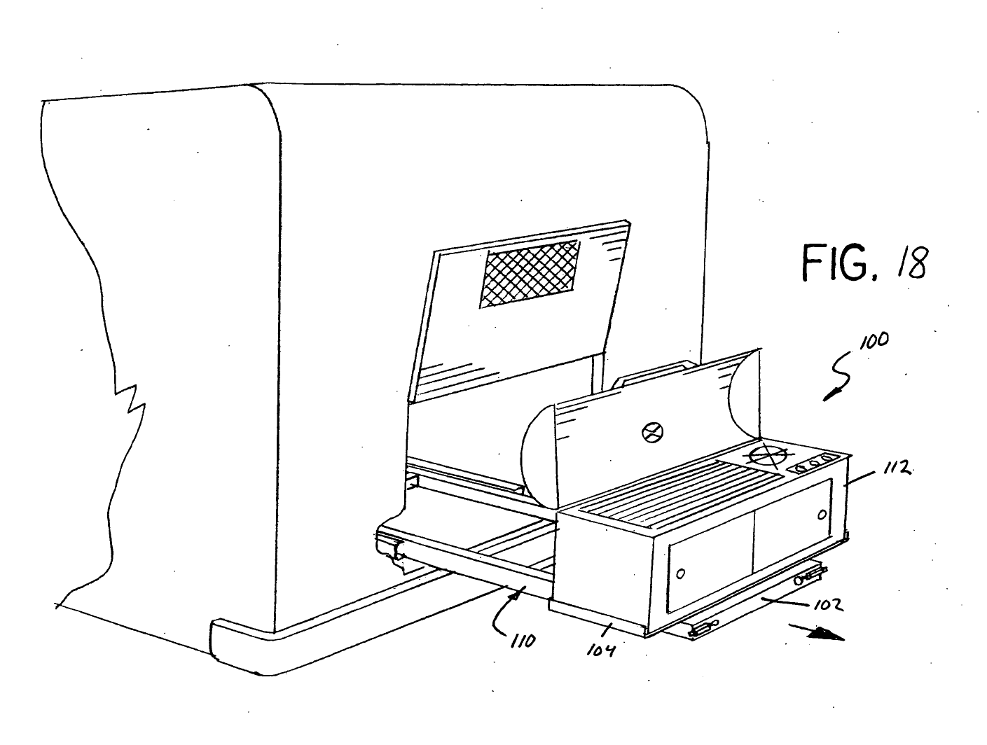

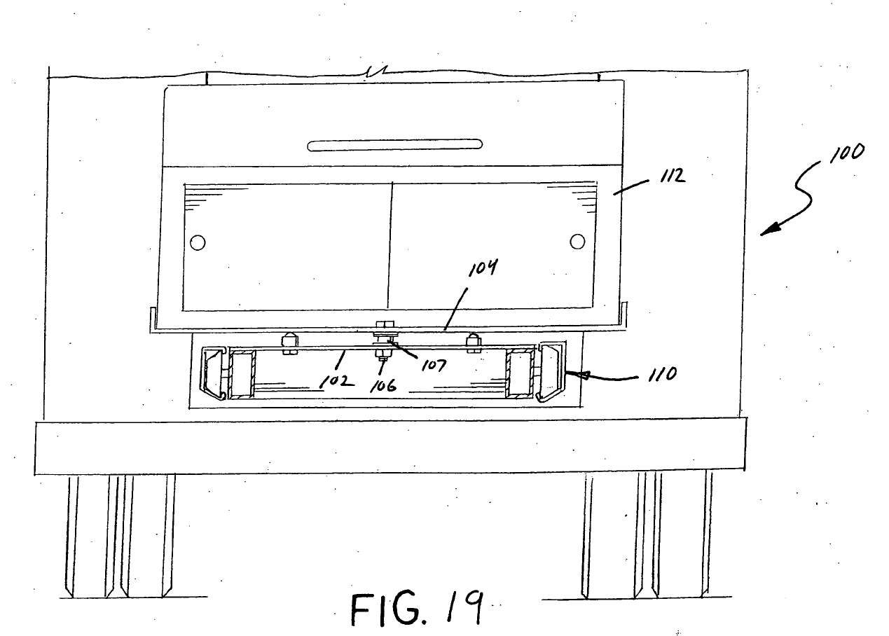

FIGS. 10-17 illustrate another undercarriage storage slide-out unit embodiment of this invention, which is generally designated as reference numeral 50. Slide-out unit 50 includes a flat equipment tray 52 mounted beneath the undercarriage, which can be manually pulled between a storage position and an extended position. This embodiment of the slide-out undercarriage storage assembly is designed to allow large or heavy equipment and supplies to be easily accessible. Ideally, equipment such as electric generators can be mounted to the extensible tray and readily shifted between a storage position beneath the undercarriage and an extended functional position. While this embodiment is illustrated supporting an electric generator unit 8, it can be used to support or store, other types of equipment, luggage or any other item.

Slide tray 52 is shiftably mounted between two frame rails 60. As shown, slide tray 52 has a rectangular bottom 54 and two integral side rails 70. Tray rails 70 are nested with corresponding frame rails 60. Slide tray 52 rides along frame rails 60 on three track rollers 80, 82 and 84, which are mounted to the frame and tray rails to allow tray 52 to shift longitudinally about the frame rails. As with the embodiment of FIGS. 1-9, frame rails 60 consist of lengths of elongated channel and have an integral flat back 62, a perpendicular flat flange 64 and a V-shaped flange (referred to as V-flange) 66. Likewise, tray rails 70 also have a flat back 72, which terminates in a V-shaped flange (V-flange) 76.

As in the first embodiment, track rollers 80, 82 and 84 are mounted in a substantially vertical position, such that the axis of rotation of the track rollers are substantially orthogonal to the longitudinal axis of rails. Each track roller 80, 82 and 84 is rotatably mounted to a frame or slide rail on axle 86 and is free to spin about the axle. Track roller 80 is mounted to the front end of frame rail 60. Track rollers 82 are rotatably mounted to the back end of tray rails 70 and track rollers 84 are rotatably mounted at an intermediate position to tray rails 70. V-flange 66 of frame rails 60 has slanted inner faces 67 that provide a race for rollers 84. V-flange 76 of tray rails 70 has slanted inner faces 77 that provide a race for track roller 80. Flat flange 64 of frame rails 60 has an inner face 65 that provides a race for roller 82. Again, each track roller 80, 82 and 84 is mounted to frame rails 60 and slide rails 70 to be in constant rolling contact with either flat flange 64 or V-flanges 66 and 76 of the other rail.

As generally shown, frame rails 60 are welded or otherwise secured to undercarriage beams 4 with tray 52 suspended between the frame rails beneath the undercarriage. In the storage position, most of the weight of tray 52 is carried by track rollers 80 and 84. As tray 52 is pulled out and slide rails 70 are extended from frame rails 60 past half their length, the weight of tray 52 rides on track rollers 80 and 82 where track rollers 82 ride under flat flanges 64 of frame rails 60.

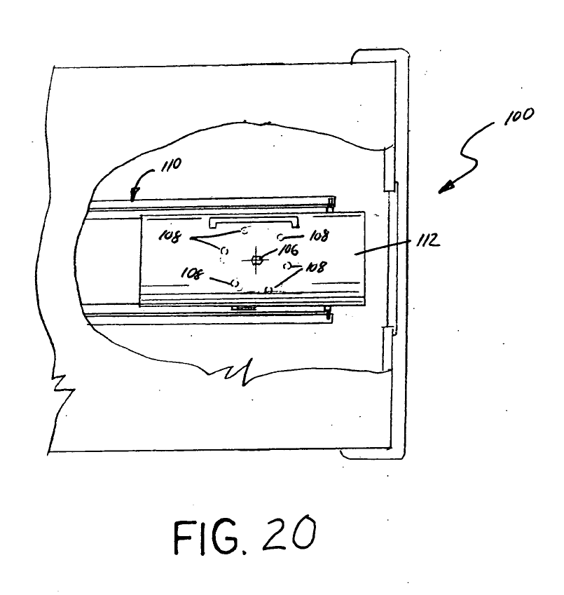

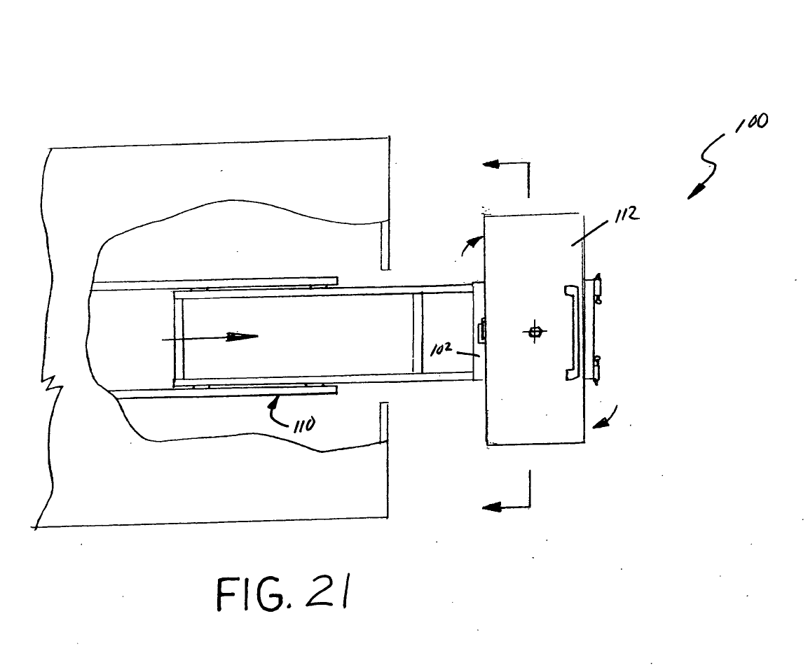

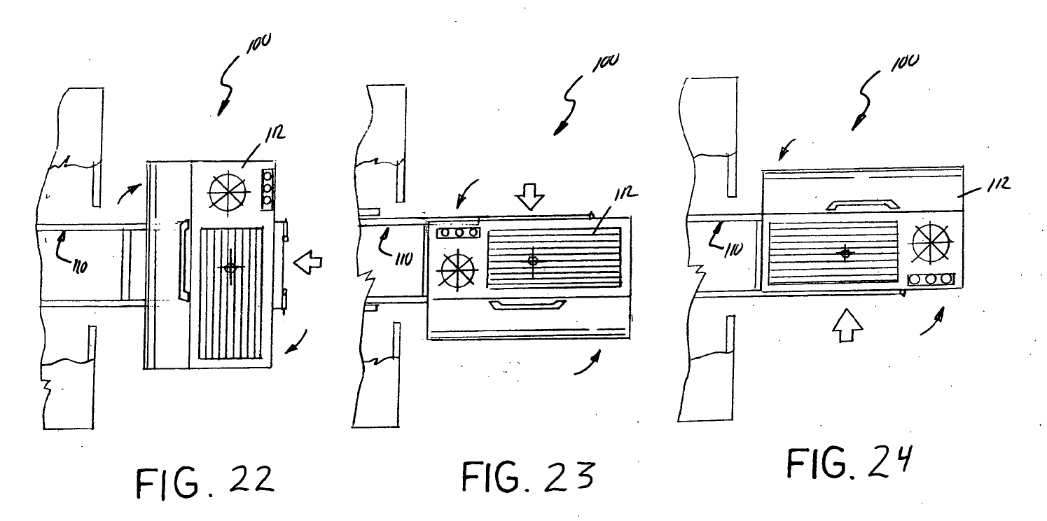

FIGS. 18-24 illustrate a third undercarriage storage slide-out unit embodiment of this invention, which is generally designated as reference numeral 100. Slide-out unit 100 uses an identical slide-out mechanism 110 as used in slide-out unit embodiment 50 and includes a swivel top 104 mounted atop the slide tray 102. Swivel top 104 rotates about a bolt 106 and bushing 107 and rides on six ball bearing rollers 108. Again, slide-out mechanism 110 allows the slide-out tray to be moved between a retracted position (FIG. 20) and an extended position (FIG. 21). As shown in FIGS. 22-24, swivel top 104 allows equipment, such as a cooking grill 112 to be pivoted 360° when tray 102 is fully extended.

One skilled in the art will note that each undercarriage storage slide-out unit embodiment of the present invention allows ready access to items stored beneath the undercarriage of vehicles by allowing the storage bin or tray to be manually pulled between a retracted storage position and an extended open position. The slide-out mechanism of each embodiment allows the bins or trays to be easily shifted between the retracted and extend positions, regardless of the weight of the items carried by the bins or trays. The use of the V-shaped flanges on the rails and three track rollers prevents binding and ensures that the bins and trays slide easily even under a heavy load.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A slide-out apparatus for vehicles having an undercarriage, the apparatus comprising:
a pair of first rails mounted beneath the undercarriage;
a pair of second rails, each of the pair of second rails nested within one of the pairs of first rails for extensible longitudinal movement therefrom;
first track rollers rotatably mounted to each of the pair of first rails;
second track rollers rotatably mounted to each of the pair of second rails; and
third track rollers rotatably mounted to each of the pair of second rails between the second track rollers and the first track rollers when the second rail is nested within one of the pairs of the first rails; and
a tray mounted between the pair of second rails,
the pair of first rails has a first flange wherein the third track rollers are in rolling contact with the first flange and a second flange wherein the second track rollers are in rolling engagement with the second flange, the pair of second rails has a third flange wherein the first track rollers are in rolling engagement with the first flange.

2. The slide-out apparatus of claim 1 wherein the first flange and the third flange each have a v-shape cross section.

3. The slide-out apparatus of claim 1 wherein the tray includes a swivel top rotatably mounted atop the tray.

4. A slide-out apparatus for vehicles having an undercarriage, the apparatus comprising:
a pair of first rails mounted to the undercarriage;
a pair of second rails, each of the pair of second rails nested within one of the pairs of first rails for extensible longitudinal movement therefrom;
first track rollers rotatably mounted to each of the pair of first rails;
second track rollers rotatably mounted to each of the pair of second rails; and
third track rollers rotatably mounted to each of the pair of second rails between the second tracks roller and the first track rollers when the second rail is nested within one of the pairs of the first rails; and
a storage bin mounted between the pair of second rails,
the pair of first rails has a first flange wherein the third track rollers are in rolling contact with the first flange and a second flange wherein the second track rollers are in rolling engagement with the second flange, the pair of second rails has a third flange wherein the first track rollers are in rolling engagement with the first flange.

5. The slide-out apparatus of claim 10 wherein the first flange and the third flange each have a v-shape cross section.
